(19) United States
(12) Patent Application Publication
(10) Pub. No.: US 2021/0081006 A1
(43) Pub. Date: Mar. 18, 2021

(54) DISPLAY DEVICE

(71) Applicant: Samsung Display Co., LTD., Yongin-si (KR)

(72) Inventor: Kyu Bong JUNG, Asan-si (KR)

(73) Assignee: Samsung Display Co., LTD., Yongin-si (KR)

(21) Appl. No.: 16/935,838

(22) Filed: Jul. 22, 2020

(30) Foreign Application Priority Data
Sep. 17, 2019 (KR) 10-2019-0114063

(51) Int. Cl. G06F 1/16; G09F 9/30; G06F 3/041

(52) U.S. Cl. CPC G06F 1/1681; G06F 3/0412; G09F 9/301; G06F 1/1652

(57) ABSTRACT

A display device includes a first panel including an input section, a second panel, a hinge section disposed between the first panel and the second panel, the hinge section being extended to the first panel and the second panel, a controller that receives an input signal from the input section and generates a control signal, and a hinge driving section that drives the hinge section based on the control signal from the controller.

### CROSS-REFERENCE TO RELATED APPLICATION(S)

This application claims priority to and benefits of Korean Patent Application No. 10-2019-0114063 under 35 U.S.C. § 119, filed in the Korean Intellectual Property Office on Sep. 17, 2019, the entire contents of which are incorporated herein by reference.

### BACKGROUND

### 1. Technical Field

The disclosure relates to a display device that may be deformable.

### 2. Description of the Related Art

A display device such as a liquid crystal display (LCD), an organic light emitting diode (OLED) display, etc. includes a display panel including pixels that can display an image. Recently, a deformable display device having a deformable shape such as a bendable or foldable panel has been developed.

The above information disclosed in this Background section is only for enhancement of understanding of the background of the invention and therefore it may contain information that does not form the prior art that is known to a person of ordinary skill in the art before the effective priority date of this disclosure.

### SUMMARY

Embodiments according to the disclosure may improve a user's convenience and security, and convenience of movement of a display device by automatically controlling deformation of the display device according to an input command by the user.

A display device according to an embodiment of the invention may include a first panel including an input section, a second panel, a hinge section disposed between the first panel and the second panel, the hinge section being extended to the first panel and the second panel, a controller that receives an input signal from the input section and generates a control signal, and a hinge driving section that drives the hinge section based on the control signal from the controller.

The hinge driving section may drive the hinge section to form a first angle between the first panel and the second panel when the input section receives a first pattern, and the hinge driving section may drive the hinge section to form a second angle between the first panel and the second panel when the input section receives a second pattern.

The first panel may include a first display section that displays an image, and the input section may include a touch sensor disposed in the first display section of the first panel. The touch sensor may sense a touch from an outside.

The first panel may include an edge display section disposed at an edge of the first panel, and the input section may be disposed in the edge display section of the first panel.

The edge display section may be disposed at a side opposite to the hinge section.

The input section may include icons or buttons, and the hinge section may be driven according to at least one selected from the icons or the buttons such that an angle between the first panel and the second panel varies based on the at least one selected from the icons or the buttons.

The input section may include a fingerprint sensor.

The hinge section may include a motor.

The hinge section may include a plurality of hinges.

The first panel may include a first display section that is exposed outside and displays an image when the first panel and the second panel form a first angle, the first panel may include a second display section that is exposed outside and displays an image when the first panel and the second panel form a second angle, and the second panel may include a third display section that is exposed outside and displays an image when the first panel and the second panel form the second angle.

A display device according to an embodiment of the invention may include panels at least one of which includes an input section, a hinge section disposed between adjacent ones of the panels, the hinge section being extended to the adjacent ones of the panels, a controller that receives an input signal from the input section and generates a control signal, and a hinge driving section that drives the hinge section based on the control signal from the controller. The input section may receive a command input by a user, and the hinge driving section may drive the hinge section according to the command input such that an angle between the adjacent ones of the panels varies based on the command input.

The hinge driving section may drive the hinge section to form a first angle between a first panel and a second panel when the input section receives a first pattern, and the hinge driving section may drive the hinge section to form a second angle between the first panel and the second panel when the input section receives a second pattern.

Each of the panels may include a display section that displays an image, and the input section may be disposed in the display section and may include a touch sensor that senses a touch from an outside.

The angle between the adjacent ones of the panels may vary according to number of instances of an input pattern input to the input section.

The input section may include a fingerprint sensor.

The hinge section may include a motor.

The hinge section may include a plurality of hinges.

The panels may include a first panel and a second panel. The first panel may include a first display section that is exposed outside and displays an image when the first panel and a second panel form a first angle, and a second display section that is exposed outside and displays an image when the first panel and the second panel form a second angle, and the second panel may include a third display section that is exposed outside and displays an image when the first panel and the second panel form the second angle.

A display device according to an embodiment of the invention may include an input section that receives a command input by a user and generate an input signal, a bent part that is bendable and includes a hinge section, a controller that receives the input signal from the input section and generates a control signal, and a hinge driving section that drives the hinge section based on the control signal from the controller. The bent part may further include a panel overlapping the hinge section. The panel may include a display section that displays an image, and the hinge driving section may drive the hinge section according to the command input such that a curvature or a bent angle of the bent part varies based on the command input.

The hinge section may include a motor.

According to embodiments of the invention, the deformation of the display device may be automatically controlled according to the command input by the user, thereby improving user convenience, security, and convenience of movement of the display device.

### BRIEF DESCRIPTION OF THE DRAWINGS

FIG. 1 is a schematic block diagram showing a structure of a display device according to an embodiment of the invention.

FIG. 2 is a schematic view showing a bent state of a display device according to an embodiment of the invention.

FIG. 3 is a schematic view showing a type of command that may be input to an input section of a display device by a user according to an embodiment of the invention.

FIG. 4 is a schematic view showing a hinge section of a display device according to an embodiment of the invention.

FIG. 5 is a schematic view showing a motor included in a hinge section of a display device according to an embodiment of the invention.

FIG. 6 is a schematic view showing an opened state of a display device according to an embodiment of the invention.

FIG. 7 is a flowchart schematically illustrating a method of modifying a display device by inputting a command to the display device according to an embodiment of the invention.

FIG. 8 is a schematic view showing a closed state of a display device according to an embodiment of the invention.

FIG. 9 is a schematic side view of a display device according to an embodiment of the invention.

FIG. 10 is a schematic side view of a display device according to an embodiment of the invention.

FIG. 11, FIG. 12, FIG. 13, and FIG. 14 are schematic side views showing a shape of various angles formed by a panel of a display device according to an embodiment of the invention.

FIG. 15 is a schematic side view showing an unfolded state of a display device according to an embodiment of the invention.

FIG. 16 is a schematic side view showing a folded state of a display device according to an embodiment of the invention.

FIG. 17 is a schematic view showing a hinge section of a display device according to an embodiment of the invention.

FIG. 18 is a schematic view showing a state where a hinge section of a display device shown in FIG. 17 may be bent.

FIG. 19 is a schematic view showing a front surface of a display device according to an embodiment of the invention.

FIG. 20 is a schematic upper side view of a bent part of a display device according to an embodiment of the invention, and

FIG. 21 is a schematic upper side view of a bent part of a display device according to an embodiment of the invention.

### DETAILED DESCRIPTION OF THE EMBODIMENTS

The invention will be described more fully hereinafter with reference to the accompanying drawings, in which embodiments of the invention are shown. As those skilled in the art would realize, the described embodiments may be modified in various different ways, all without departing from the spirit or scope of the invention.

In order to clarify the invention, parts that may not be a focal point may be omitted. The same elements or equivalents may be referred to with the same reference numerals throughout the specification.

Also, the size and thickness of each element may be arbitrarily shown in the drawings, but the invention is not necessarily limited thereto, and in the drawings, the thickness of layers, films, panels, regions, etc., may be exaggerated for clarity and convenience of description.

It will be understood that when an element such as a layer, film, region, or substrate is referred to as being “on” another element, it can be directly on the other element or intervening elements may also be present. In contrast, when an element is referred to as being “directly on” another element, there may be no intervening elements present. Further, in the specification, the word “on” or “above” may mean positioned on or below the object section, and does not necessarily mean positioned on the upper side of the object section based on a gravitational direction.

Unless explicitly described to the contrary, terms such as “comprise”, “has”, “have”, and “include”, and variations such as “comprises”, “comprising”, “having”, “includes”, and “including” will be understood to imply the inclusion of stated elements but not the exclusion of any other elements.

In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

Terms such as “overlap” may include layer, stack, face or facing, extending over, extending under, covering or partly covering or any other suitable term as would be appreciated and understood by those of ordinary skill in the art.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 5% of the stated value.

Unless otherwise defined, all terms used herein (including technical and scientific terms) have the same meaning as commonly understood by those skilled in the art to which this disclosure pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the specification.

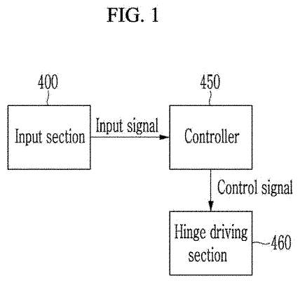

Now, a structure and an operation of a display device according to an embodiment of the invention are described with reference to FIG. 1 to FIG. 7.

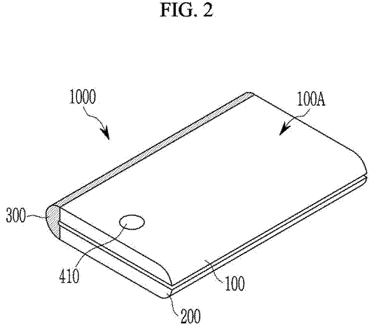

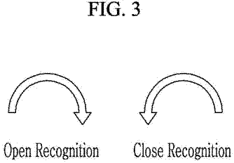

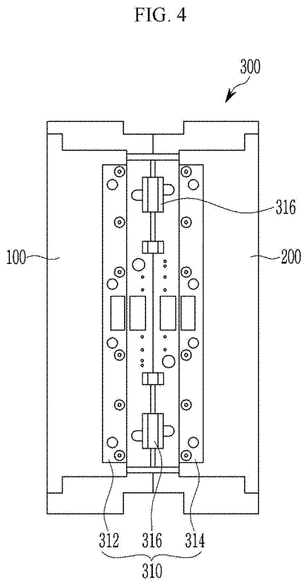

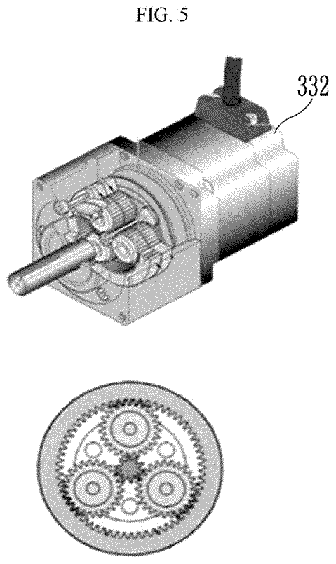

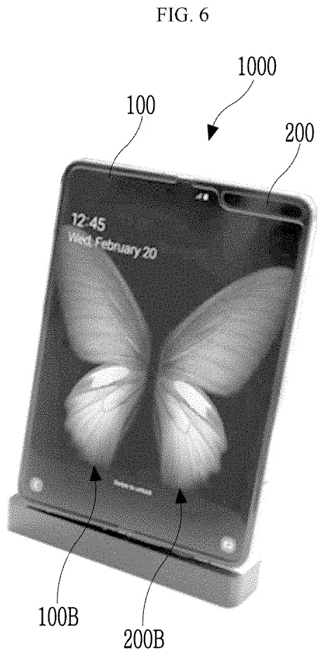

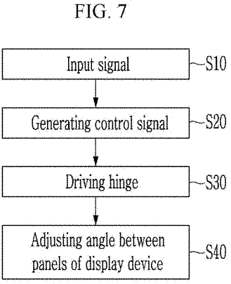

FIG. 1 is a schematic block diagram showing a structure of a display device according to an embodiment of the invention. FIG. 2 is a schematic view showing a bent state of a display device according to an embodiment of the invention. FIG. 3 is a schematic view showing a type of command that may be input to an input section of a display device by a user according to an embodiment of the invention. FIG. 4 is a schematic view showing a hinge section of a display device according to an embodiment of the invention. FIG. 5 is a schematic view showing a motor included in a hinge section of a display device according to an embodiment of the invention. FIG. 6 is a schematic view showing an opened state of a display device according to an embodiment of the invention. FIG. 7 is a flowchart schematically illustrating a method of modifying a display device by inputting a command to the display device according to an embodiment of the invention.

First referring to FIG. 1, a display device according to an embodiment of the invention may include an input section 400, a controller 450, and a hinge driving section 460.

The input section 400 may receive a user's command and generate an input signal according thereto. For example, the input section 400 may include a button of the display device or an icon displayed on the display section of the display device. The display section on which the icon may be displayed may include a touch sensor capable of sensing a direct touch from the outside, a hovering touch, or the like.

The controller 450 may receive an input signal from the input section 400 and generate a control signal. The control signal may be a control signal for the driving or changing the state of the hinge section included in the display device.

The hinge driving section 460 may drive the hinge of the hinge section included in the display device based on the control signal of the controller 450.

Referring to FIG. 2, a display device 1000 according to an embodiment of the invention may include a first panel 100, a second panel 200, and a hinge section 300.

The first panel 100 may include a display section 100A capable of displaying an image according to an input image signal. The second panel 200 may also include a display section for displaying an image according to the input image signal.

The hinge section 300 may include at least one hinge that can be automatically controlled by the hinge driving section 460. The hinge section 300 may be disposed between the first panel 100 and the second panel 200, and may be extended to the first panel 100 and the second panel 200.

The angle between the first panel 100 and the second panel 200 may be adjusted according to the state of the hinge included in the hinge section 300 which may be automatically driven. In case that the hinge of the hinge section 300 is completely closed, as shown in FIG. 2, the first panel 100 and the second panel 200 of the display device 1000 may be completely closed to be parallel to each other. The display section 100A of the first panel 100 may be exposed to the outside.

In the disclosure, the state in which the first panel 100 and the second panel 200 are closed or the display device is closed may include, in addition to a completely closed state, a closed state while being formed to an angle. For example, the state in which the first panel 100 and the second panel 200 are closed or the display device is closed may mean a state except for a completely opened state. Similarly, the state in which the first panel 100 and the second panel 200 are opened or the display device is opened also may include an opened state while forming an angle in addition to a fully opened state. For example, the state in which the display device is opened the first panel 100 and the second panel 200 are opened may mean a state excluding the completely closed state.

The first panel 100 may include at least one input section 410. The input section 410 may be a part corresponding to the above-described input section 400 and may be disposed in the display section 100A. The input section 410 may include an icon in a form such as a button displayed on the display section 100A, or may include an actual button that can be pressed. The input section 410 may include a touch sensor that can sense a direct touch from the outside, a hovering touch, or the like.

According to an embodiment of the invention, the touch sensor may include a fingerprint sensor.

Different input signals may be generated according to a command input by a user to the input section 410 of the display device 1000 shown in FIG. 2. The form of the command or the input pattern that may be distinguishable by the input section 410 may be previously stored in a memory of the display apparatus 1000. In case that the touch sensor included in the input section 410 includes a fingerprint sensor, information about a user's fingerprint may be previously stored in the memory of the display device 1000.

Referring to FIG. 3, if the user touches or presses an opening input pattern on the input section 410, for example, while moving in a clockwise direction or a right side as shown in the left side of FIG. 3, the hinge driving section 460 may be operated according to the control signal of the controller 450 and the hinge section 300 of the display device 1000 shown in FIG. 2 may be driven, thereby the first panel 100 and the second panel 200 may be opened to an angle. The angle may be set in various ways, and for example, the angle between the first panel 100 and the second panel 200 may be about 10 degrees, about 20 degrees, . . . , about 90 degrees, . . . , about 180 degrees, or the like according to a command input.

On the contrary, if the user touches or presses a closing input pattern on the input section 410, for example, while moving in a counterclockwise direction or to the left as shown on the right side of FIG. 3, the hinge driving section 460 may be operated according to the control signal of the controller 450 and the hinge section 300 of the display device 1000 shown in FIG. 2 may be driven, thereby the first panel 100 and the second panel 200 may be closed to an angle. The angle may be set in various ways, and for example, the angle between the first panel 100 and the second panel 200 may be about 10 degrees, about 20 degrees, . . . , about 90 degrees, . . . , about 180 degrees, or the like according to one command input.

According to an embodiment of the invention, the driving of the hinge section 300 may be controlled according to the fingerprint information of the user inputted by the touch to the input section 410. For example, in case that the fingerprint information of the user input to the input section 410 matches pre-stored fingerprint information, the hinge section 300 may be driven to open the first panel 100 and the second panel 200. If it does not match, the hinge part 300 may not be driven, and thus the first panel 100 and the second panel 200 may maintain a closed state. Accordingly, only a user who may be previously designated by the display device 1000 may open the first panel 100 and the second panel 200, thereby improving security of the display device 1000.

The input method or input pattern of the command input to the input section 410 may vary, and thus the operation of the hinge section 300 may also vary. For example, a range in which the hinge section 300 operates, for example, the degree of the hinge included in the hinge section 300 or the angle between the first panel 100 and the second panel 200 may vary according to various input methods or input patterns of the commands input to the input sections 400 and 410.

Referring to FIG. 4, the hinge section 300 included in the display device according to an embodiment of the invention may include at least one hinge 310. The hinge 310 may include a first supporting member 312, a second supporting member 314, and a rotation part 316.

The first supporting member 312 may be fixed and extended to the first panel 100, and the second supporting member 314 may be fixed and extended to the second panel 200.

The rotation part 316 may be disposed between the first supporting member 312 and the second supporting member 314, and may be extended to the first supporting member 312 and the second supporting member 314. The first supporting member 312 and the second supporting member 314 may be rotated based on the rotation part 316, and accordingly, the first panel 100 and the second panel 200 may be rotated based on the rotation part 316.

Referring to FIG. 5, the hinge section 300 may include a motor 332 that may allow the hinge 310 to automatically move according to the input command. The motor 332 may be disposed at the rotation part 316.

Referring to FIG. 6, the hinge section 300 may be driven according to the command input to the input sections 400 and 410 as above-described such that the first panel 100 and the second panel 200 may be opened, and display sections 100B and 200B of the first panel 100 and the second panel 200 may be exposed to the outside. The display sections 100B and 200B may display the image according to the input image signal. For example, in the state that the first panel 100 and the second panel 200 are opened, the first panel 100 may include the display section 100B capable of displaying the image, and the second panel 200 may include the display section 200B capable of displaying the image. The display section 100B of the first panel 100 and the display section 200B of the second panel 200 may be disposed on a same plane.

Referring to FIG. 2 and FIG. 6, the display section 100A and the display section 100B of the first panel 100 may be disposed on opposite surfaces of the first panel 100, respectively.

An operation method of the display device according to an embodiment of the invention is described with reference to FIG. 7 along with FIG. 1 to FIG. 6.

As described above, if the command is input to the input sections 400 and 410 of the display device by the user, the input signal may be generated (S10).

Next, the controller 450 may determine the command and generates the control signal according to the input signal (S20).

Then, the hinge driving section 460 may drive the hinge 310 according to the control signal from the controller 450 (S30).

The display device may then be deformed by adjusting the angle between the first panel 100 and the second panel 200 of the display device according to the driving of the hinge 310 (S40).

As described above, according to an embodiment of the invention, the display device 1000 may include the hinge section 300, and the display device 1000 may be automatically deformed according to the state of the hinge section 300 according to the user's command. For example, the positional relationship or angle between the first panel 100 and the second panel 200 extended to the hinge section 300 may be automatically controlled. The user's command may be implemented through (e.g., input by) the touch on the display section 100A (e.g., the input section 410), so that the user may conveniently control the opened/closed state of the display device 1000. As described above, in case that the touch sensor included in the input section 410 includes the fingerprint sensor, only the user who may be previously designated (e.g., by the display device 1000) may open the first panel 100 and the second panel 200. Thereby, the security of the display device 1000 may be improved.

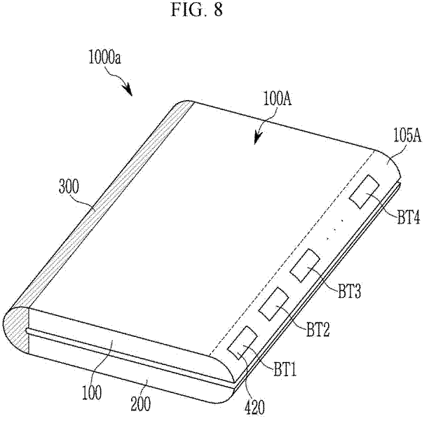

Next, the display device according to an embodiment of the invention is described with reference to FIG. 8 to FIG. 14 together with the above-described drawings.

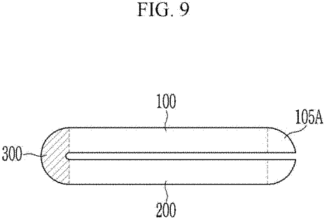

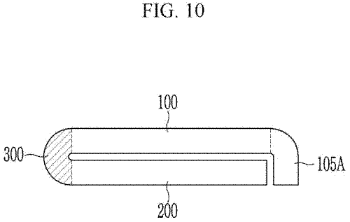

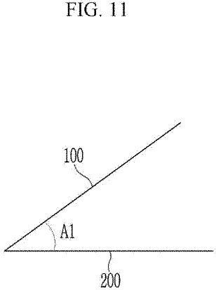

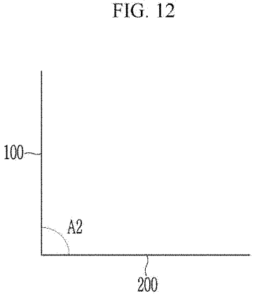

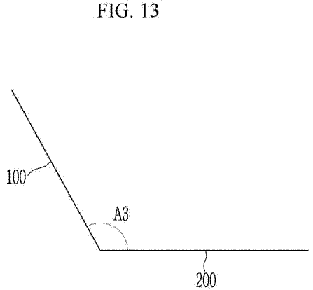

FIG. 8 is a schematic view showing a closed state of a display device according to an embodiment of the invention. FIG. 9 is a schematic side view of a display device according to an embodiment of the invention. FIG. 10 is a schematic side view of a display device according to an embodiment of the invention. FIG. 11, FIG. 12, FIG. 13, and FIG. 14 are schematic side views showing a shape of various angles formed by a panel of a display device according to an embodiment of the invention.

Referring to FIG. 8, a display device 1000a according to the embodiment of the invention may be substantially the same as the display device 1000 described above. The first panel 100 of the display device 1000a may be different from the first panel 100 of the display device 1000.

The first panel 100 may include at least one input section 420. The input section 420 may be a part corresponding to the input section 400 described above, and may be disposed at a different position from the input section 410 of the display device 1000 illustrated in FIG. 2.

The first panel 100 may include an edge display section 105A positioned at an edge, and the input section 420 may be positioned at the edge display section 105A. The edge display section 105A may be disposed at the edge of the side opposite to the hinge section 300 of the first panel 100, but is not limited thereto.

The edge display section 105A may have a shape extending along one edge of the first panel 100, and may form a side surface of the first panel 100.

Referring to FIG. 9, the edge display section 105A may have a display surface that may be bent (or curved) at the edge of the first panel 100. At least one input section 420 may be disposed on the bent display surface.

Referring to FIG. 10, the edge display section 105A may be bent at the edge of the first panel 100 (or curved), thereby forming the side part of the first panel 100. At least one input section 420 may be disposed on the display surface of the edge display section 105A.

Referring back to FIG. 8, at least one input section 420 disposed on the edge display section 105A may include icons BT1, BT2, BT3, and BT4 in the form of a button displayed by the edge display section 105A. As another example, input section 420 may include actual buttons that may be pressed. As another example, input section 420 may include a touch sensor capable of sensing a direct touch from the outside, a hovering touch, or the like.

According to an embodiment of the invention, the touch sensor may include a fingerprint sensor.

Different input signals may be generated according to the command input by the user to the input section 420 of the display device 1000a illustrated in FIG. 8. The form or input pattern of the command recognized by the input section 420 may be previously stored in a memory of the display device 1000a. In case that the touch sensor included in the input section 420 includes the fingerprint sensor, information about the user's fingerprint may be previously stored in the memory of the display device 1000a.

When one of the buttons or icons BT1, BT2, BT3, and BT4 displayed or positioned on the edge display section 105A is the input section 420, different control signals may be generated according to the shape or the input pattern of the command that may be input or touched by the user to the input section 420, and thus the hinge section 300 may be driven accordingly.

As described above with reference to FIG. 3, if the user touches or presses the opening input pattern of the input section 420, for example, while moving in the clockwise or rightward direction, the hinge section 300 of the display device 1000a may be driven such that the first panel 100 and the second panel 200 may be opened at an angle. The angle may be set in various ways, and for example, the angle between the first panel 100 and the second panel 200 may be about 10 degrees, about 20 degrees, . . . , about 90 degrees, . . . , about 180 degrees, or the like according to a command input.

For example, referring to FIG. 11 to FIG. 14, in the case of the display device capable of distinguishing the various input patterns or shapes input to the input section 420, the hinge section 300 may be driven such that the angles between the first panel 100 and the second panel 200 may form various angles A1, A2, A3, and A4 according to the input patterns or shapes. The input patterns or shapes may be different from each other. The angles A1, A2, A3, and A4 may be different from each other. Various ones of the input patterns or shapes may correspond to various ones of the angles A1, A2, A3, and A4.

In contrast, if the user touches or presses the closing input pattern of the input section 420, for example, while moving in the counterclockwise direction or leftward, the hinge section 300 of the display device 1000a may be driven such that the first panel 100 and the second panel 200 may be closed to an angle. The angle may be set in various ways, and for example, the angle between the first panel 100 and the second panel 200 may be about 10 degrees, about 20 degrees, . . . , about 90 degrees, . . . , about 180 degrees, or the like according to one command input.

According to another embodiment of the invention, the hinge section 300 may be driven such that the angles between the first panel 100 and the second panel 200 may form the various angles A1, A2, A3, and A4 according to the number of instances of the input pattern or input shape.

For example, if the opening input pattern or shape is input one time to the input section 420, the hinge section 300 may be driven so that the first panel 100 and the second panel 200 may be opened to the angle A1 shown in FIG. 11. If the opening input pattern or shape is input to the input section 420 two times, three times, or four times, the hinge section 300 may be driven so that the first panel 100 and the second panel 200 may be opened to the angles A2, A3, and A4 shown in FIG. 12, FIG. 13, or FIG. 14.

In contrast, if the closing input pattern or shape is input one time, in the input section 420, the hinge section 300 may be driven so that the first panel 100 and the second panel 200 may be closed to the angle A3 shown in FIG. 13, and if the closing input pattern or shape is input to the input section 420 two times, three times, or four times, the hinge section 300 may be driven so that the first panel 100 and the second panel 200 may be opened to angles A2, A1, or about 0 degrees, as shown in FIG. 12, FIG. 11, or FIG. 8.

Accordingly, the opening and closing of the display device 1000a including the first panel 100 and the second panel 200 may be automatically controlled at various angles according to the method of inputting the command to the input section 420 and/or the input pattern, thereby increasing the user's convenience.

When the touch sensor of the input section 420 includes the fingerprint sensor, the driving of the hinge section 300 may be controlled according to the fingerprint information of the user input by the touch to the input section 420. For example, in case that the fingerprint information of the user inputted to the input section 420 matches the pre-stored fingerprint information, the hinge section 300 may be driven to open the first panel 100 and the second panel 200. In case that the fingerprint information of the user inputted to the input section 420 and the pre-stored fingerprint information do not match, the hinge section 300 may not be driven, and thus the first panel 100 and the second panel 200 may maintain a closed state. Accordingly, the first panel 100 and the second panel 200 may be opened only by the user who may be previously designated by the display device 1000a, thereby improving the security of the display device 1000a.

When the input section 420 includes buttons or icons BT1, BT2, BT3, and BT4 displayed or positioned on the edge display section 105A, the user may touch or press one among the buttons or icons BT1, BT2, BT3, and BT4. The hinge section 300 may be driven differently according to the selected button or icon BT1, BT2, BT3, and BT4.

For example, in case that the user touches or presses the button or icon BT1, the hinge section 300 of the display device 1000a may be driven to drive the first panel 100 and the second panel 200 to be opened or closed to an angle. The angle may be variously set, and for example, the angle change between the first panel 100 and the second panel 200 according to the position or type of the selected button or icon BT1, BT2, BT3, and BT4 may be opened or closed to about 10 degrees, about 20 degrees, . . . , about 90 degrees, . . . , about 180 degrees, or the like. Some of the various angles between the first panel 100 and the second panel 200 are as shown in FIG. 11 to FIG. 14.

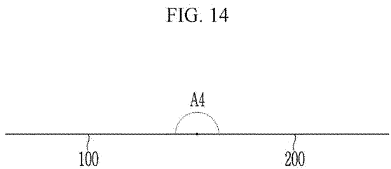

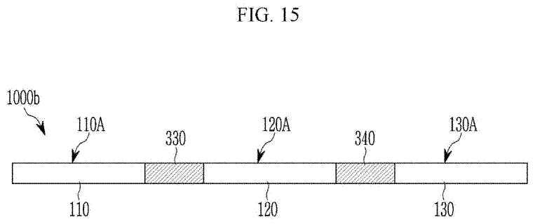

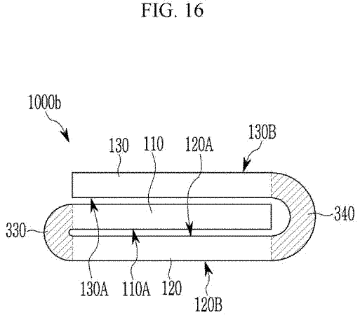

Next, the display device according to an embodiment of the invention is described with reference to FIG. 15 and FIG. 16 along with the above-described drawings.

FIG. 15 is a schematic side view showing an unfolded state of a display device according to an embodiment of the invention, and FIG. 16 is a schematic side view showing a folded state of a display device according to an embodiment of the invention.

The display device 1000b according to an embodiment may be substantially the same as the display devices 1000 and 1000a described above, but may include hinge sections 330 and 340.

The display device 1000b according to an embodiment may include panels 110, 120, and 130 and hinge sections 330 and 340.

The hinge section 330 and 340 may be disposed between the panels 110, 120, and 130 that may be adjacent to each other. Each hinge section 330 and 340 may be extended to two neighboring panels 110, 120, and 130.

In the state that the display device 1000b is unfolded, each panel 110, 120, and 130 may expose display sections 110A, 120A, and 130A capable of displaying the image according to each input image signal.

Each of the hinge sections 330 and 340 may include at least one hinge that may be automatically controlled, and the display device 1000b may be automatically and variously modified according to the hinge state. For example, as shown in FIG. 15, the display device 1000b may be fully unfolded or opened according to the hinge states of the hinge sections 330 and 340. As another example, the display device 1000b may be completely folded or closed as shown in FIG. 16.

As illustrated in FIG. 16, in case that the display device 1000b is fully folded or closed, the panels 110, 120, and 130 may be substantially parallel to each other. The panels 120 and 130 viewed from the outside in case that the display device 1000b is fully folded or closed may include display sections 120B and 130B capable of displaying the image according to the input image signal, respectively.

At least one of the panels 110, 120, and 130 may include at least one of the various input sections 400, 410, and 420 described above. According to various commands input by the user to the input sections 400, 410, and 420, the display device 1000b may be deformed at various angles or shapes. According to the various states of the hinges included in the hinge sections 330 and 340, the angle between the adjacent panels 110, 120, and 130 may be controlled in various ways in addition to the states in which the display device 1000b may be fully opened as shown in FIG. 15 and the display device 1000b may be completely closed or folded as shown in FIG. 16.

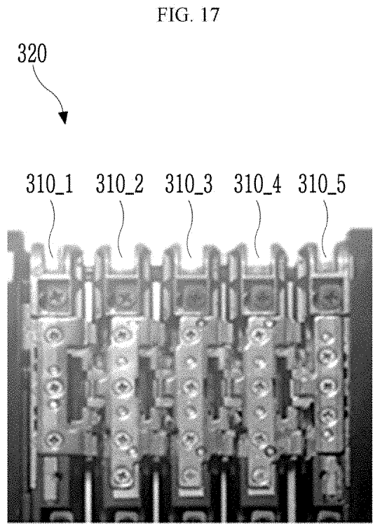

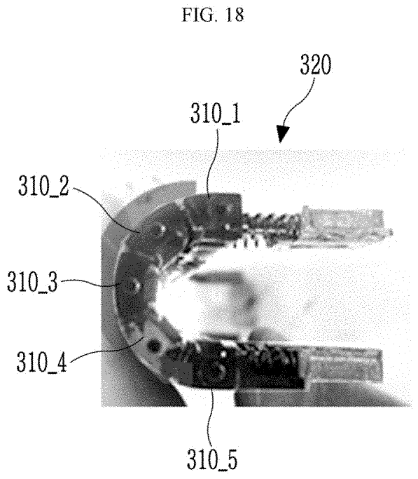

Next, another example of the hinge section included in the display device according to an embodiment of the invention is described with reference to FIG. 17 and FIG. 18 along with the drawings described above.

FIG. 17 is a schematic view showing a hinge section of a display device according to an embodiment of the invention, and FIG. 18 is a schematic view showing a state where a hinge section of a display device shown in FIG. 17 may be bent.

Referring to FIG. 17 and FIG. 18, the hinge section 300 included in the display devices 1000, 1000a, and 1000b according to an embodiment of the invention may include a hinge section 320 including hinges 310_1, 310_2, 310_3, 310_4, and 310_5. The hinges 310_1, 310_2, 310_3, 310_4, and 310_5 may be connected to each other. As described above, each hinge 310_1, 310_2, 310_3, 310_4, and 310_5 may include the rotation part 316 as described above, thereby enabling rotation based on the hinges 310_1, 310_2, 310_3, 310_4, and 310_5. Therefore, the angle between the panels included in the display device may be controlled in various ways as compared with the case in which the hinge section 300 includes one hinge.

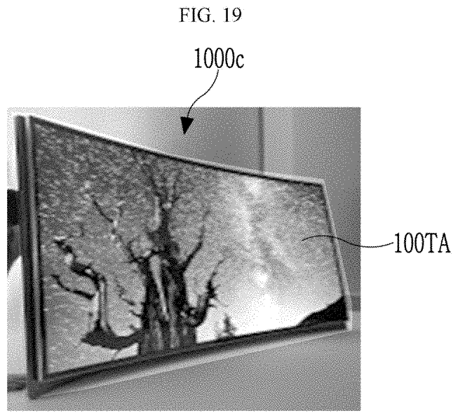

Next, the display device according to an embodiment of the invention is described with reference to FIG. 19 to FIG. 21 along with the drawings described above.

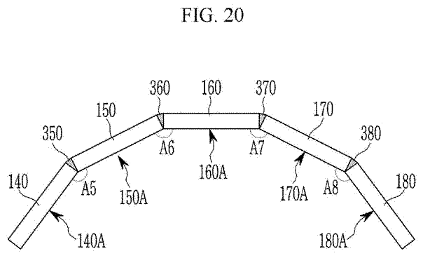

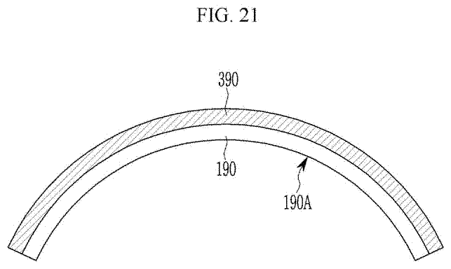

FIG. 19 is a schematic view showing a front surface of a display device according to an embodiment of the invention, FIG. 20 is a schematic upper side view of a bent part of a display device according to an embodiment of the invention, and FIG. 21 is a schematic upper side view of a bent part of a display device according to an embodiment of the invention.

Referring to FIG. 19, the display device 1000c according to an embodiment of the invention may include a bent part 100TA that may be bent or curved.

Referring to FIG. 19 and FIG. 20, the bent part 100TA of the display device 1000c according to an embodiment of the invention may include panels 140, 150, 160, 170, and 180 capable of displaying the image, and hinge sections 350, 360, 370, and 380. The hinge sections 350, 360, 370, and 380 may be disposed between the neighboring panels 140, 150, 160, 170, and 180 to connect two adjacent panels 140, 150, 160, 170, and 180.

Each panel 140, 150, 160, 170, and 180 may include the display section 140A, 150A, 160A, 170A, and 180A capable of displaying the image according to each input image signal.

Each of the hinge sections 350, 360, 370, and 380 may include at least one hinge that may be automatically controlled, and the bent part 100TA of the display device 1000c may be automatically and variously modified according to the hinge state.

Specifically, according to the hinge state of the hinge sections 350, 360, 370, and 380, as shown in FIG. 20, the angles A5, A6, A7, and A8 between the adjacent panels 140, 150, 160, 170, and 180 may be adjusted. The angles A5, A6, A7, and A8 may be substantially the same as or different from each other. In case that the angles A5, A6, A7, and A8 are all about 180 degrees, the bent part 100TA of the display device 1000c may be substantially flat, and as the angles A5, A6, A7, and A8 become smaller, the bent part 100TA of the apparatus 1000c may be in a curved state with a gradually smaller curvature.

At least one of the panels 140, 150, 160, 170, and 180 may include at least one of the various input sections 400, 410, and 420 described above. According to various commands input by the user to the input sections 400, 410, and 420, the display device 1000c may be deformed at various angles or shapes.

Referring to FIG. 19 and FIG. 21, the bent part 100TA of the display device 1000c according to an embodiment of the invention may include one panel 190 capable of displaying the image and a hinge section 390. The panel 190 and the hinge section 390 may overlap each other. The bent part 100TA may have a flat shape or may have a curved shape with various curvatures. For example, the bent part 100TA may be deformed.

The panel 190 may include a display section 190A capable of displaying the image.

The hinge section 390 may include hinges, such as the hinge section 320 illustrated in FIG. 17 described above. According to the states of the hinges, the panel 190 included in the bent part 100TA of the display device 1000c may be deformed at the various bending angles or various curvatures. As the hinge section 390 may include a large number of hinges, the panel 190 may have a smoother curved shape. Each hinge may be automatically driven through the controller and the hinge driving section according to the various commands input to the input section as described above, so that the panel 190 may be conveniently deformed with the various bending angles or various curvatures.

While this invention has been described in connection with what is considered to be practical embodiments, it is to be understood that the invention is not limited to the disclosed embodiments. On the contrary, it is intended to cover various modifications and equivalent arrangements included within the spirit and scope of the appended claims, including any equivalents.

What is claimed is:

1. A display device comprising:
a first panel including an input section;
a second panel;
a hinge section disposed between the first panel and the second panel, the hinge section being extended to the first panel and the second panel;
a controller that receives an input signal from the input section and generates a control signal; and
a hinge driving section that drives the hinge section based on the control signal from the controller.

2. The display device of claim 1, wherein
the hinge driving section drives the hinge section to form a first angle between the first panel and the second panel when the input section receives a first pattern, and
the hinge driving section drives the hinge section to form a second angle between the first panel and the second panel when the input section receives a second pattern.

3. The display device of claim 2, wherein
the first panel includes a first display section that displays an image, and
the input section includes a touch sensor disposed in the first display section of the first panel, wherein the touch sensor senses a touch from an outside.

4. The display device of claim 2, wherein
the first panel includes an edge display section disposed at an edge of the first panel, and
the input section is disposed in the edge display section of the first panel.

5. The display device of claim 4, wherein
the edge display section is disposed at a side opposite to the hinge section.

6. The display device of claim 4, wherein
the input section includes icons or buttons, and
the hinge section is driven according to at least one selected from the icons or the buttons such that an angle between the first panel and the second panel varies based on the at least one selected from the icons or the buttons.

7. The display device of claim 1, wherein the input section includes a fingerprint sensor.

8. The display device of claim 1, wherein the hinge section includes a motor.

9. The display device of claim 1, wherein the hinge section includes a plurality of hinges.

10. The display device of claim 1, wherein
the first panel includes a first display section that is exposed outside and displays an image when the first panel and the second panel form a first angle,
the first panel includes a second display section that is exposed outside and displays an image when the first panel and the second panel form a second angle, and
the second panel includes a third display section that is exposed outside and displays an image when the first panel and the second panel form the second angle.

11. A display device comprising:
panels at least one of which includes an input section;
a hinge section disposed between adjacent ones of the panels, the hinge section being extended to the adjacent ones of the panels;
a controller that receives an input signal from the input section and generates a control signal; and
a hinge driving section that drives the hinge section based on the control signal from the controller, wherein the input section receives a command input by a user, and
the hinge driving section drives the hinge section according to the command input such that an angle between the adjacent ones of the panels varies based on the command input.

12. The display device of claim 11, wherein
the hinge driving section drives the hinge section to form a first angle between a first panel and a second panel when the input section receives a first pattern, and
the hinge driving section drives the hinge section to form a second angle between the first panel and the second panel when the input section receives a second pattern.

13. The display device of claim 12, wherein
each of the panels includes a display section that displays an image, and
the input section is disposed in the display section and includes a touch sensor that senses a touch from an outside.

14. The display device of claim 11, wherein
the angle between the adjacent ones of the panels varies according to a number of instances of an input pattern input to the input section.

15. The display device of claim 11, wherein the input section includes a fingerprint sensor.

16. The display device of claim 11, wherein the hinge section includes a motor.

17. The display device of claim 11, wherein the hinge section includes a plurality of hinges.

18. The display device of claim 11, wherein
the panels includes a first panel and a second panel,
the first panel includes:
a first display section that is exposed outside and displays an image when the first panel and the second panel form a first angle; and
a second display section that is exposed outside and displays an image when
the first panel and the second panel form a second angle, and
the second panel includes a third display section that is exposed outside and displays an image when the first panel and the second panel form the second angle.

19. A display device comprising:
an input section that receives a command input by a user and generates an input signal;
a bent part that is bendable and includes a hinge section;
a controller that receives the input signal from the input section and generates a control signal; and
a hinge driving section that drives the hinge section based on the control signal from the controller, wherein
the bent part further includes a panel overlapping the hinge section,
the panel includes a display section that displays an image, and
the hinge driving section drives the hinge section according to the command input such that a curvature or a bent angle of the bent part varies based on the command input.

20. The display device of claim 19, wherein the hinge section includes a motor.
